(19) United States
(12) Patent Application Publication
(10) Pub. No.: US 2026/0311239 A1
(43) Pub. Date: Oct. 8, 2026

(54) PROMPT CONTENT DISPLAY METHOD, ELECTRONIC DEVICE AND STORAGE MEDIUM

(71) Applicant: Beijing Youzhuju Network Technology Co., Ltd., Beijing (CN)

(72) Inventors: Qiang FU, Beijing (CN); Cai HE, Beijing (CN); Jiali HU, Beijing (CN); Liya LI, Beijing (CN); Zhiyao XIE, Beijing (CN)

(21) Appl. No.: 19/484,836

(22) PCT Filed: Apr. 29, 2024
(86) PCT No.: PCT/CN2024/090536

§ 371 Date: Nov. 14, 2025

(30) Foreign Application Priority Data
Jul. 10, 2023 (CN) 202310842373.2

(51) Int. Cl. G06Q 30/0601; H04N 21/2187; H04N 21/431; H04N 21/478

(52) U.S. Cl. CPC G06Q 30/0631; H04N 21/2187; H04N 21/431; H04N 21/47815

(57) ABSTRACT

A prompt content display method, an electronic device and a storage medium are provided. The method includes: receiving a first trigger operation for a preset control in a live streaming page; in response to the first trigger operation, determining a first recommended object in the live streaming page according to a status of a recommended object in a recommended object list corresponding to the live streaming page, and acquiring first prompt content corresponding to the first recommended object; and displaying the first prompt content in the live streaming page.

This application claims the priority to and benefits of the Chinese Patent Application No. 202310842373.2, which was filed on Jul. 10, 2023. The aforementioned Chinese patent application is hereby incorporated by citation in its entirety as part of the present application.

### TECHNICAL FIELD

Embodiments of the present disclosure relate to a prompt content display method and apparatus, an electronic device and a storage medium.

### BACKGROUND

With the continuous development of science and technology, the live streaming industry emerges, users may display recommended objects, such as products, in the live streaming page. In order to better display, the users need to introduce the recommended objects, and how to introduce the products is the key point in the preparation process of live streaming. In some cases, product recommendation effect may be greatly improved with prompt content.

However, existing prompt content display methods are cumbersome in interaction, causing inconvenience to the introduction of the recommended object to a certain extent.

### SUMMARY

Embodiments of the present disclosure provide a prompt content display method and apparatus, an electronic device and a storage medium.

An embodiment of the present disclosure provides a prompt content display method, comprising:
receiving a first trigger operation for a preset control in a live streaming page;
in response to the first trigger operation, determining a first recommended object in the live streaming page according to a status of a recommended object in a recommended object list corresponding to the live streaming page, and acquiring first prompt content corresponding to the first recommended object; and
displaying the first prompt content in the live streaming page.

An embodiment of the present disclosure provides a prompt content display apparatus, comprising:
a receiving module, configured to receive a first trigger operation for a preset control in a live streaming page;
an acquisition module, configured to: in response to the first trigger operation, determine a first recommended object in the live streaming page according to a status of a recommended object in a recommended object list corresponding to the live streaming page, and acquire first prompt content corresponding to the first recommended object; and
a content display module, configured to display the first prompt content in the live streaming page.

An embodiment of the present disclosure provides an electronic device, comprising:
one or more processors; and
a memory configured to store one or more computer programs;
when the one or more computer programs are executed by the at least one processor, the one or more processors implement the prompt content display method according to the embodiments of the present disclosure.

An embodiment of the present disclosure provides a computer-readable storage medium, wherein the computer-readable storage medium stores a computer program which, when executed by a processor, implement the prompt content display method according to the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flow schematic diagram of a prompt content display method provided by an embodiment of the present disclosure;

FIG. 2 is a flow schematic diagram of displaying a preset control provided by an embodiment of the present disclosure;

FIG. 3 is a flow schematic diagram of a first prompt content provided by an embodiment of the present disclosure;

FIG. 4 is a schematic diagram of adjusting a display position of first prompt content provided by an embodiment of the present disclosure;

FIG. 5 is a flow schematic diagram of canceling a prompt provided by an embodiment of the present disclosure;

FIG. 6 is a flow schematic diagram of displaying a prompt panel provided by an embodiment of the present disclosure;

FIG. 7 is a flow schematic diagram of another prompt content display method provided by an embodiment of the present disclosure;

FIG. 8 is a structural schematic diagram of a prompt content display apparatus provided by an embodiment of the present disclosure; and

FIG. 9 is a structural schematic diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to“ at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user may choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

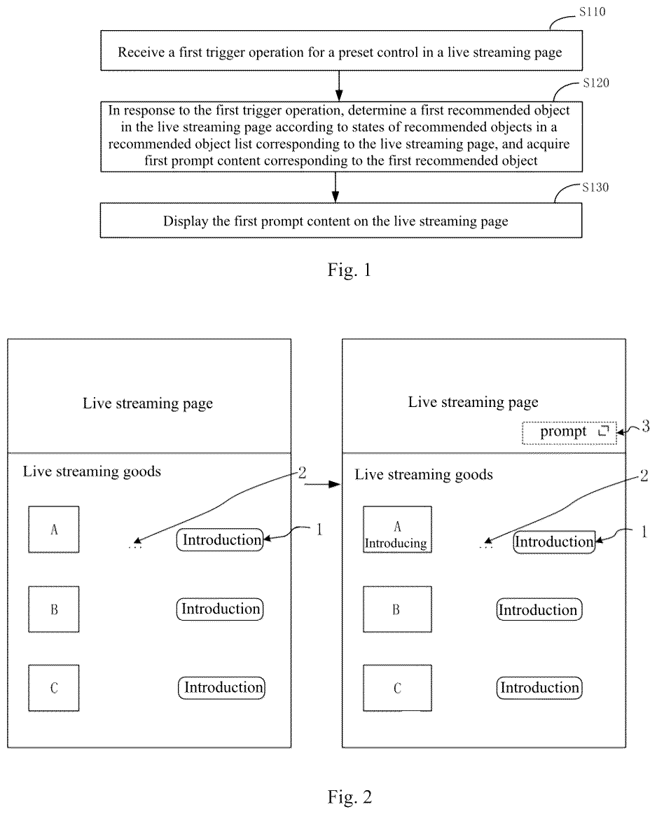

FIG. 1 is a flow schematic diagram of a prompt content display method provided by an embodiment of the present disclosure; the method is applicable to displaying of prompt content for an introduced object in a live streaming page, and may be performed by a prompt content display apparatus; the apparatus may be implemented by software and/or hardware and is generally integrated on an electronic device; and the electronic device in the embodiment includes but is not limited to: a computer, a mobile phone or a tablet personal computer and the like.

As shown in FIG. 1, the prompt content display method provided by the embodiment of the present disclosure includes the following steps:

S110: receiving a first trigger operation for a preset control in a live streaming page.

The preset control may be a control set in advance and be configured to trigger to acquire and display a prompt content of a recommended object. Exemplarily, a user (such as a streamer) may introduce a recommended object in the live streaming process; and in order to cooperate with the user to introduce, the user may perform the first trigger operation on the preset control in the live streaming page so as to display a prompt content in the live streaming page, wherein the recommended object may be goods and the like, and the recommended object as the goods is taken as an example for illustrating. The specific style and position of the preset control in the live streaming process are not limited, which may be set by a configuration person according to actual conditions. For example, the preset control may be a prompter in a folded status. The first trigger operation is a trigger operation for the preset control. For example, the first trigger operation may be an operation of single-clicking or double-clicking the preset control.

In the embodiment, the user may perform the first trigger operation on the preset control in the live streaming page, and in response to detect the first trigger operation for the preset control, the electronic device may receive the first trigger operation to perform subsequent detection and display steps.

S120: in response to the first trigger operation, determining a first recommended object in the live streaming page according to states of recommended objects in a recommended object list corresponding to the live streaming page, and acquiring first prompt content corresponding to the first recommended object.

The first recommended object may be understood as a recommended object which is introduced currently in the live streaming page. The first prompt content is the prompt content corresponding to the first recommended object and facilitates the introduction of the first recommended object by the user. The specific content of the first prompt content is not limited, for example, the prompt content may be edited by the user in advance.

In one embodiment, the first prompt content is a recommended prompt content or a prompt content edited by the user, and the prompt content edited by the user is obtained by the user editing at a local terminal and/or other terminals than the local terminal.

In the embodiment, the first prompt content may be the recommended prompt content, the recommended prompt content may be a content generated according to relevant information of the first recommended object, and the relevant information includes, for example, keywords of the first recommended object, and user comments. The recommended prompt content may also be the prompt content used by other users according to the first recommended object, or basic information of the first recommended object. The recommended object list includes a plurality of recommended objects.

The first prompt content may also be the prompt content edited by the user, such as the prompt content edited by the user before live streaming or during live streaming. Further, the prompt content edited by the user may be obtained by the user from the local terminal and/or other terminals than the local terminal. The local terminal may be understood as terminal equipment used by the user in current live streaming, and the other terminals may be understood as terminals different from the local terminal, such as a central control device; the central control device may control the live streaming process of the user, correspondingly, the first prompt content may be edited through the central control device; and when it needs to be displayed, the first prompt content is controlled to be displayed in the live streaming page of the local terminal. Exemplarily, the local terminal may be a mobile terminal, and the central control device may be a computer terminal.

For a certain recommended object, when there is the prompt content edited by the user for the recommended object, the prompt content edited by the user may be used as the prompt content corresponding to the recommended object; and when there is no prompt content edited by the user for the recommended object, the recommended prompt content corresponding to the recommended object may be used as the prompt content corresponding to the recommended object.

After the first trigger operation for the preset control in the live streaming page is received, in response to the first trigger operation, the first recommended object may be determined according to the status of the recommended object in the recommended object list corresponding to the live streaming page, and after the first recommended object is determined, the first prompt content corresponding to the first recommended object is acquired. In the embodiment, the determination of the first recommended object and the acquisition of the first prompt content are not limited. Exemplarily, when there are recommended objects to be introduced, the first recommended object may be determined according to introduction statuses of the recommended objects, for example, the recommended object in a current introducing status is determined as the first recommended object, and the recommended objects in non-introducing statuses are determined as the recommended objects other than the first recommended object. The introduction statuses may be determined according to the display status of an introduction control. For example, each recommended status may correspond to one introduction control; when a certain recommended object is being introduced, a corresponding introduction control may displayed as “introducing”, and when a certain recommended object is not being introduced, the corresponding introduction control may be displayed as “to be introduced”. Also, the introduction statuses may be determined according to the display status of the recommended object. For example, when a certain recommended object is being introduced, the display status of the recommended object may display an identifier of “introducing”, and when a certain recommended object is not being introduced, the display status of the recommended object may not display the identifier of “introducing”.

Further, the mode of determining a first object in response to that there is the recommended object in a teleprompting status and the mode of determining the first object in response to that there is no recommended object in the teleprompting status may also be different. Exemplarily, in response to that there is a recommended object in the teleprompting status, the recommended object in the teleprompting status may be directly determined as the first recommended object; in response to that there is no recommended object in the teleprompting status, the recommended object in the introducing status may be determined as the first recommended object. In response to that there is no recommended object in the introducing status, a certain recommended object or a previous prompt content recommended or introduced object may be used as the first recommended object at the moment, which may be configured according to actual conditions. The teleprompting status may be determined according to the display status of the preset control or the display status of the prompt content.

In one embodiment, only one preset control may be displayed in the live streaming page, or a plurality of preset controls may be displayed in the live streaming page. When one preset control is displayed in the live streaming page, the recommended object with the introduction identifier may be determined as the first recommended object, or, the first recommended object which is introduced currently is identified and determined according to a live streaming picture displayed in the live streaming page. When a plurality of preset controls are displayed in the live streaming page, the first recommended object may be determined according to the position of triggering the preset controls. For example, each recommended object is correspondingly displayed with one preset control, and in this case, the first recommended object which is introduced currently may be determined according to a triggering position of the receiving first trigger operation; and an introduction operation for the recommended object before the first trigger operation is received may also be detected, and the recommended object corresponding to the introduction operation is determined as the first recommended object. It is to be noted that the time for acquiring the first prompt content corresponding to the first recommended object is not limited. For example, after the first trigger operation is performed, and in response to that the first recommended object which is introduced currently in the live streaming page is determined, the first prompt content corresponding to the first recommended object may be acquired. Further, the prompt content corresponding to one or more recommended objects may be confirmed in advance before the first trigger operation is performed, for example, the first prompt content corresponding to the first recommended object; and in response to that the first trigger operation is received, the first recommended object may be directly determined and the first prompt content corresponding to the first recommended object may be acquired.

S130: displaying the first prompt content on the live streaming page.

After the first prompt content corresponding to the first recommended object is acquired through the above steps, the acquired first prompt content may be displayed in the live streaming page, and the display means is not limited. For example, a mask containing the first prompt content may be generated in the live streaming page to realize the display of the first prompt content; or, the first prompt content may also be displayed by changing the display form of the preset control on the basis of the preset control, for example, the preset control may be adjusted from a folded status to an unfolded status.

In one embodiment, the displaying the first prompt content in the live streaming page includes:
increasing a size of the preset control into a target size, and displaying the first prompt content in the preset control with the target size, wherein the target size is determined based on the first prompt content.

The target size is the adjusted size of the preset control, and the specific target size may be determined based on the first prompt content. For example, the target size may be adaptively adjusted according to the amount of words in the first prompt content. The specific size of the target size may also be further adjusted according to the size of the live streaming page. For example, in response to that there are too many words in the first prompt content, and the target size is larger than a preset size of the live streaming page, the target size may be set to be the maximum preset size, and the first prompt content is browsed by sliding up and down.

Specifically, in the process of displaying the first prompt content in the live streaming page, the size of the preset control may be increased into the target size, and the first prompt content is displayed in the preset control with the target size. Moreover, it is supported to drag the preset control with the target size in the live streaming page along a preset direction. The preset direction may be, for example, a transverse direction or a vertical direction.

FIG. 2 is a flow schematic diagram of displaying a preset control provided by an embodiment of the present disclosure. As shown in FIG. 2, the introduction operation (such as clicking a control 1) for a recommended object A may be performed in the live streaming page to perform the control display operation, the preset control is switched from an un-displayed status to a displayed status, for example, it is displayed in live streaming page that the recommended object A is being introduced, and the preset control (a control 3 as shown in the figure) may be displayed.

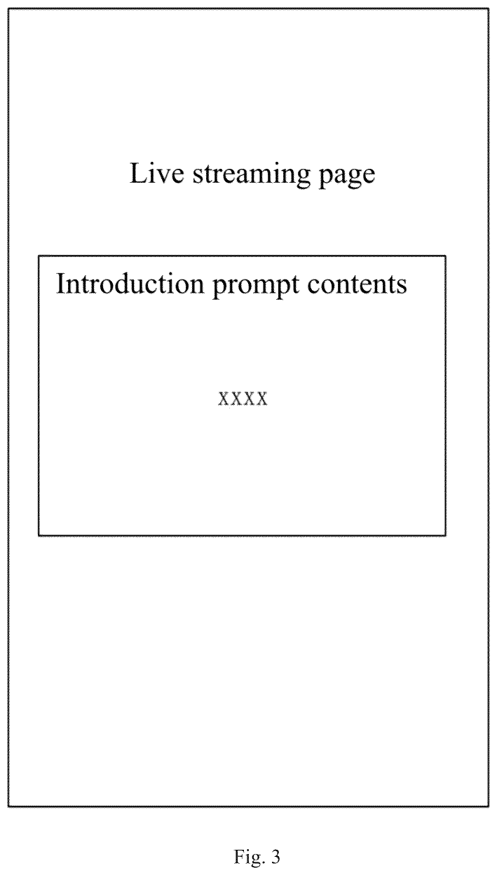

FIG. 3 is a flow schematic diagram of a first prompt content provided by an embodiment of the present disclosure. As shown in FIG. 3, clicking the preset control may be regarded as performing the first trigger operation, so that the electronic device may be in response to the first trigger operation to acquire and display the first prompt content corresponding to the first recommended object, that is, the size of the preset control is increased into the target size in FIG. 3, and the first prompt content is displayed in the preset control with the target size.

The prompt content display method provided by the embodiment of the present disclosure includes: receiving a first trigger operation for a preset control in a live streaming page; in response to the first trigger operation, determining a first recommended object in the live streaming page according to the status of a recommended object in a recommended object list corresponding to the live streaming page, and acquiring the first prompt content corresponding to the first recommended object; and displaying the first prompt content in the live streaming page. Through the method, the first recommended object in the live streaming page is determined in response to the first trigger operation for the preset control, so that acquisition and display of the first prompt content are realized, the interaction steps in displaying of the prompt content are simplified, and thus the user experience is improved.

In one embodiment, after displaying the first prompt content in the live streaming page, the method further includes at least one of:
in response to an introduced object switching operation for a third recommended object, switching a currently introduced object of the live streaming page from the first recommended object to the third recommended object, and switching a current prompt content displayed in the live streaming page from the first prompt content to a third prompt content, the third prompt content being a prompt content corresponding to the third recommended object; and
in response to a prompt content switching operation for a fourth recommended object, keeping the currently introduced object of the live streaming page as the first recommended object, and switching the current prompt content displayed in the live streaming page from the first prompt content to a fourth prompt content, the fourth prompt content being the prompt content corresponding to the fourth recommended object.

The introduced object switching operation may be used for switching the current introduced object of the live streaming page, for example, the introduced object switching operation may be an operation of clicking introduction controls corresponding to other introduced objects, and the other introduced objects are introduced objects other than the current introduced object. The third recommended object is an introduced object other than the first recommended object, and the third prompt content may be the prompt content corresponding to the third recommended object.

The prompt content switching operation may be used for switching the current prompt content displayed on the live streaming page, the fourth recommended object is an introduced object other than the first recommended object, the fourth recommended object may be the third recommended object, and also may be an introduced object other than the first recommended object and the third recommended object; and the fourth prompt content is the prompt content corresponding to the fourth recommended object.

In one embodiment, after the first prompt content is displayed in the live streaming page, the current prompt content displayed in the live streaming page may be correspondingly switched while the currently introduced object is switched. Exemplarily, in the embodiment, in response to the introduced object switching operation for the third recommended object, the currently introduced object of the live streaming page is switched from the first recommended object to the third recommended object, and the current prompt content displayed in the live streaming page is switched from the first prompt content to the third prompt content.

In one embodiment, after the first prompt content is displayed in the live streaming page, only the current prompt content displayed in the live streaming page may be switched while the currently introduced object is kept unchanged. Exemplarily, in the embodiment, in response to the prompt content switching operation for the fourth recommended object, the currently introduced object of the live streaming page is kept to be the first recommended object, and the current prompt content displayed in the live streaming page is switched from the first prompt content to the fourth prompt content.

In one embodiment, the displaying the first prompt content in the live streaming page includes:
displaying the first prompt content in a preset area of the live streaming page, wherein the preset area does not overlap with a live streaming information area and an interactive information area of the live streaming page.

The method further comprises:
in response to a position adjusting operation performed in the live streaming page, adjusting a display position of the first prompt content within a preset position region, a starting position of the preset position region being a first boundary of the live streaming information area, and an ending position of the preset position region being a second boundary of the interactive information area.

In the embodiment, the preset area may be an area set in advance. For example, the preset area may be an area which does not overlap with the live streaming information area and the interactive information area of the live streaming page. The specific size and shape of the preset area may be determined according to the actual page condition. The live streaming information area may be regarded as an area for displaying live streaming related information, for example, the live streaming related information may include the number of live streaming participants. The interactive information area may be regarded as an area for displaying interactive information, and the interactive information may include like information, comment information, notification information, etc. The positions of the live streaming information area and the interactive information area in the live streaming page are not limited, and may be configured by related personnel. Exemplarily, the live streaming information area may be, for example, in a top area of the live streaming page, the interactive information area may be in an area at the lower left corner of the live streaming page, and correspondingly, the preset area may be a non-overlapping area between the live streaming information area and the interactive information area.

The position adjusting operation is used for adjusting the display position of the first prompt content. For example, the position adjusting operation may be an operation of dragging the first prompt content, or an operation of dragging the edge of a display area corresponding to the first prompt content. The starting position of the preset position region may be a first boundary of the live streaming information area, the first boundary may be, for example, a lower boundary or an upper boundary of the live streaming information area. The ending position of the preset position region may be a second boundary of the interactive information area, the second boundary may be, for example, the upper boundary or the lower boundary of the live streaming information area. Exemplarily, the starting position of the preset position region may be the lower boundary of the live streaming information area, and the ending position of the preset position region may be the upper boundary of the interactive information area.

Specifically, in the embodiment, the first prompt content may be displayed in the preset area of the live streaming page, and the preset area is specifically the area which does not overlap with the live streaming information area and the interactive information area of the live streaming page. Further, in the embodiment, the display position of the first prompt content may be adjusted. For example, in response to the position adjusting operation performed in the live streaming page, the display position of the first prompt content may be correspondingly adjusted in the preset position region. For example, the display position of the first prompt content is correspondingly adjusted according to the dragging end position of the position adjusting operation.

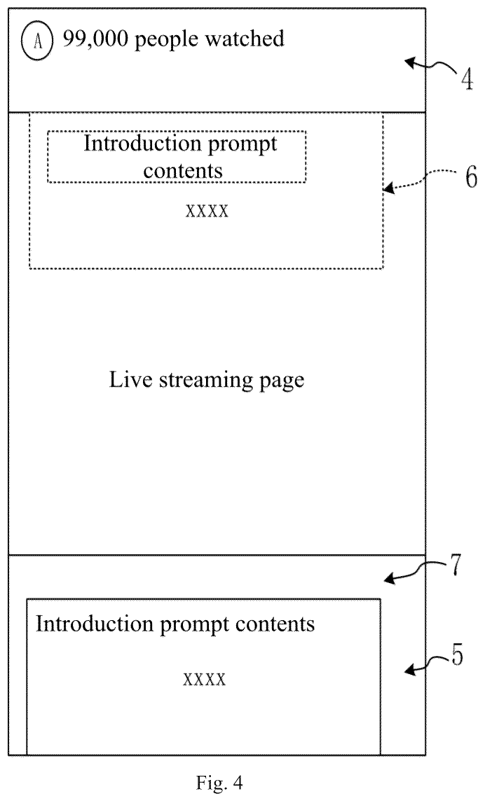

FIG. 4 is a schematic diagram of adjusting a display position of first prompt content provided by an embodiment of the present disclosure. As shown in FIG. 4, an area 4 in the live streaming page may be the live streaming information area, and an area 5 in the live streaming page may be the interactive information area; and the position adjusting operation may be performed on the first prompt content, such as long pressing an edge position 6 of the display area of the first prompt content and dragging it to a position 7, so as to adjust the display position of the first prompt content to the position shown in the figure.

In one embodiment, the method further includes:
in response to a first teleprompting canceling operation performed in the live streaming page, canceling a display of the preset control and a current prompt content displayed in the live streaming page, and adjusting a recommended object corresponding to the current prompt content to be in a preset status; and
in response to a second teleprompting canceling operation performed in the live streaming page, canceling the display of the preset control and the current prompt content displayed in the live streaming page, and adjusting the recommended object in the recommended object list to be in the preset status;
a corresponding prompt content for the recommended object in the preset status is not displayed in the live streaming page in an introduction process.

The first teleprompting canceling operation and the second teleprompting canceling operation may refer to operations of canceling the display of the preset control and the prompt content, the first teleprompting canceling operation and the second teleprompting canceling operation are not limited in the embodiment. For example, the first teleprompting canceling operation may be an operation of clicking the current prompt content, and furthermore, the second teleprompting canceling operation may also be an operation of long pressing the current prompt content. For another example, a cancel menu is displayed in the live streaming page after the operation of long pressing the current prompt content, and the first teleprompting canceling operation and the second teleprompting canceling operation may be performed in the cancel menu.

It may be recognized that the first teleprompting canceling operation and the second teleprompting canceling operation may be applied to different recommended objects, for example, the first teleprompting canceling operation is applied to the recommended object corresponding to the current prompt content, and the second teleprompting canceling operation is applied to all the recommended objects in a recommended object list corresponding to the live streaming page. In the embodiment, the corresponding prompt content for the recommended object in the preset status will not be displayed in the live streaming page in the introduction process after adjusting to the preset status.

Specifically, in one embodiment, in response to the first teleprompting canceling operation performed in the live streaming page, the display of the preset control and the current prompt content displayed in the live streaming page may be canceled, and the recommended object corresponding to the current prompt content is adjusted to be in the preset status, and thus the current prompt content is not displayed on the live streaming page in the introduction process after the current live streaming process is finished. Further, after the user performs the introduced object switching operation subsequently, the preset control may be displayed again, and prompt content corresponding to the introduced object after switching is displayed according to settings, such as automatic display or manual display.

In one embodiment, in response to the second teleprompting canceling operation in the live streaming page, the display of the preset control and the current prompt content displayed in the live streaming page may be canceled, and all recommended objects in a recommended object list corresponding to the live streaming page are adjusted to be in the preset status, so that the preset control and the prompt content corresponding to any recommended object are not displayed in the current live streaming process. Furthermore, the user may trigger an open control to restore normal display of the preset control and the prompt content corresponding to the recommended object. The open control may be displayed in a setting page.

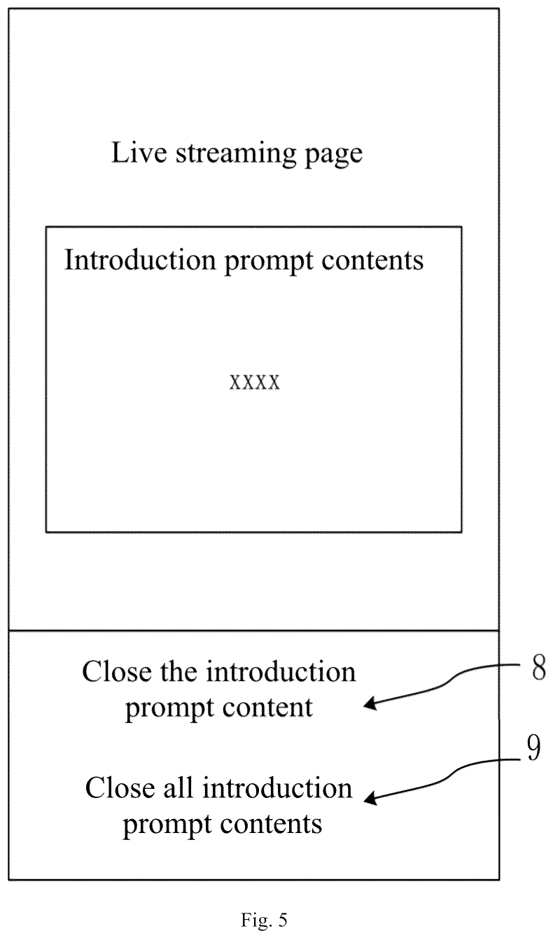

FIG. 5 is a flow schematic diagram of canceling of teleprompting provided by an embodiment of the present disclosure. As shown in FIG. 5, the preset control which displays the current prompt content or does not display the current prompt content may be long pressed to display the cancel menu in a mask of the live streaming page. For example, the user may click a control 8 to perform the first teleprompting canceling operation for the current prompt content, at the moment, the display of the preset control and the current prompt content displayed in the live streaming page may be canceled, and the recommended object corresponding to the current prompt content is adjusted to be in the preset status. For example, the user may click a control 9 to perform the second teleprompting canceling operation, at the moment, the display of the preset control and the current prompt content displayed in the live streaming page may be canceled, and the recommended object in the recommended object list corresponding to the live streaming page is adjusted to be in the preset status.

In one embodiment, the method further includes:
in response to a prompt content editing operation for a fifth recommended object, displaying a prompt panel for the fifth recommended object, wherein the prompt panel comprises an editing area and a display area, the editing area is configured to edit a fifth prompt content of the fifth recommended object, and the display area is configured to display at least one reference prompt content corresponding to the fifth recommended object;
in response to a second trigger operation for a target reference prompt content in the at least one reference prompt content, inputting the target reference prompt content into the editing area; and
in response to an editing completion operation, setting a prompt content inputted in the editing area as the fifth prompt content of the fifth recommended object.

The fifth recommended object may be any one selected from the group of the first recommended object, the second recommended object, the third recommended object and the fourth recommended object, or other recommended objects except the first recommended object, the second recommended object, the third recommended object and the fourth recommended object.

The prompt content editing operation may be used for editing the fifth prompt content corresponding to the fifth recommended object, the time of performing the prompt content editing operation is not limited. Exemplarily, the prompt content editing operation may be performed before the user starts live streaming. For example, a certain control is triggered in a live streaming starting page or a recommended object information page to perform the prompt content editing operation; or, the prompt content editing operation may also be performed in the live streaming process of the user. For example, a certain control is triggered in a live streaming goods page to perform the prompt content editing operation.

A prompt panel for the fifth recommended object may refer to a panel for editing the fifth prompt panel, and the prompt panel may include an editing area and a display area, wherein the editing area may be used for editing the fifth prompt content of the fifth recommended object, and the display area may be used for displaying at least one reference prompt content corresponding to the fifth recommended object; and the reference prompt content may be understood as a content for reference in response to that the fifth prompt content is set. For example, the reference prompt content may be the recommended prompt content. The target reference prompt content may be regarded as a certain reference prompt content in the at least one reference prompt content; and the editing completion operation may be an operation for confirming editing completion, such as an operation of clicking a certain confirmation control.

In one embodiment, in response to the prompt content editing operation for the fifth recommended object, the prompt panel for the fifth recommended object may be displayed, and the prompt panel may include the editing area and the display area; at the moment, in response to that the prompt content is not displayed in the editing area, the user may input the fifth prompt content of the fifth recommended object in the editing area, or in response to that the prompt content is displayed in the editing area, the user may edit the prompt content in the editing area, such as modification; the second trigger operation for the target reference prompt content in the at least one reference prompt content may also be performed in the display area, and at the moment, the electronic device detects the second trigger operation, and inputs the target reference prompt content into the editing area in response to the second trigger operation; and the user may modify characters of the target reference prompt content according to actual needs, or directly trigger the editing completion operation without modification, and at the moment, the electronic device may set the prompt content inputted in the editing area as the fifth prompt content of the fifth recommended object in response to the editing completion operation. On that basis, the user inputs or provides the reference prompt content to set the prompt content of the recommended object.

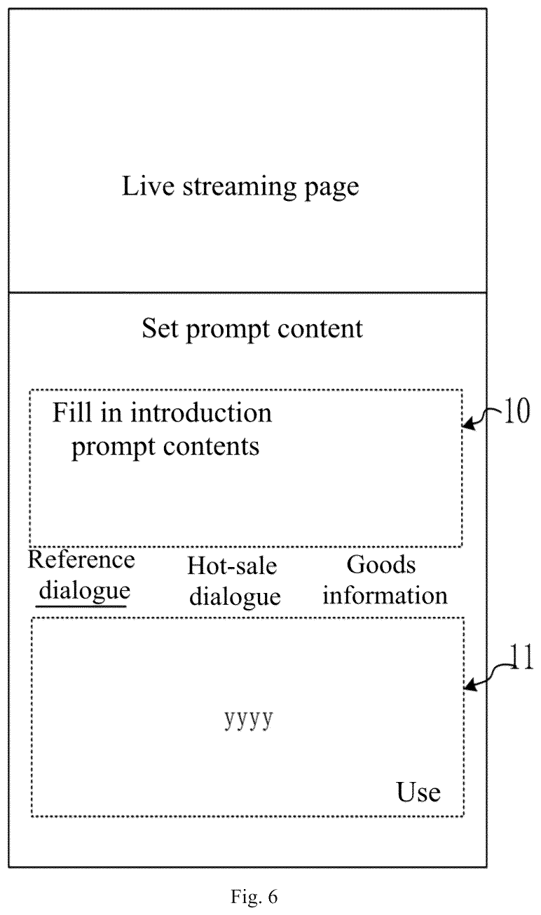

FIG. 6 is a flow schematic diagram of display of a prompt panel provided by an embodiment of the present disclosure. The prompt panel for the fifth recommended object may be displayed in the live streaming page through the control 2 (as shown in FIG. 2) in the live streaming page. As shown in FIG. 6, the prompt panel may include an editing area 10 and a display area 11, the editing area 11 may be used for editing the fifth prompt content of the fifth recommended object, and the display area 11 is used for displaying at least one reference prompt content corresponding to the fifth recommended object, such as reference dialogue, hot-sale dialogue and goods information. The reference dialogue may refer to prompt content recommended by a platform, the hot-sale dialogue may be prompt content used for the recommended object with high sales, and the goods information may be basic information of the first recommended object.

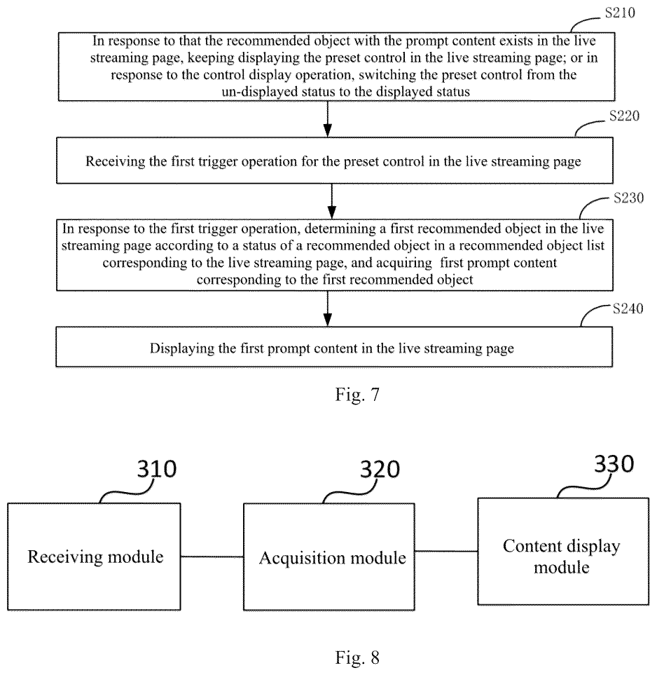

FIG. 7 is another flow schematic diagram of a prompt content display method provided by an embodiment of the present disclosure. The solution in the embodiment may be combined with one or more selectable solutions in the above embodiment. Optionally, before receiving the trigger operation for the preset control in the live streaming page, the method further includes: in response to that the recommended object with the prompt content exists in the live streaming page, keeping displaying the preset control in the live streaming page; or in response to the control display operation, switching the preset control from the un-displayed status to the displayed status.

As shown in FIG. 7, the prompt content display method provided by the embodiment of the present disclosure includes the following steps:

S210: in response to that the recommended object with the prompt content exists in the live streaming page, keeping displaying the preset control in the live streaming page; or in response to the control display operation, switching the preset control from the un-displayed status to the displayed status.

The control display operation may be used for switching the display status of the preset control, and the type of the control display operation is not limited.

In one embodiment, the control display operation includes an introduction operation or a prompt content display operation for the second recommended object; the introduction operation is used for indicating to introduce the second recommended object; and the prompt content display operation is used for indicating to display the second prompt content corresponding to the second recommended object.

The introduction operation may be used for indicating to introduce the second recommended object, for example, the introduction operation may be an operation of clicking the introduction control. The prompt content display operation may be used for indicating to display the second prompt content corresponding to the second recommended object. The second recommended object may be the first recommended object, or a recommended object different from the first recommended object.

In one embodiment, after the user performs the introduction operation for the second recommended object, the preset control may be automatically switched from the un-displayed status to the displayed status; or the preset control may also be switched from the un-displayed status to the displayed status based on the prompt content display operation performed by the user.

Specifically, before the first trigger operation for the preset control in the live streaming page is received, in response to that the recommended object with prompt content exists in the live streaming page, the preset control may be kept to be displayed in the live streaming page, so that the first trigger operation may be performed by triggering the preset control; or, in response to that the preset control is not displayed in the live streaming page, the control display operation may be performed to switch the preset control from the un-displayed status to the displayed status, so that the user may perform the first trigger operation.

S220: receiving the first trigger operation for the preset control in the live streaming page.

S230: in response to the first trigger operation, determining a first recommended object in the live streaming page according to a status of a recommended object in a recommended object list corresponding to the live streaming page, and acquiring first prompt content corresponding to the first recommended object.

S240: displaying the first prompt content in the live streaming page.

The prompt content display method provided by the embodiment of the present disclosure includes: in response to that the recommended object of the prompt content exists in the live streaming page, keeping displaying the preset control in the live streaming page; or in response to the control display operation, switching the preset control from the un-displayed status to the displayed status; receiving the first trigger operation for the preset control in the live streaming page; in response to the first trigger operation, determining the first recommended object in the live streaming page according to the status of the recommended object in a recommended object list corresponding to the live streaming page, and acquiring the first prompt content corresponding to the first recommended object; and displaying the first prompt content in the live streaming page.

The preset control is displayed in the live streaming page or the preset control is switched from the un-displayed status to the displayed status, so that a basis is provided for subsequent implementation of the first trigger operation for the preset control, and the interactive steps of displaying prompt content are further simplified.

The prompt content display method provided by the embodiment is described in an exemplary manner as follows:
firstly, for the setting of teleprompting, in the embodiment, the user may independently edit the prompt content (such as goods introduction dialogue) before or during live streaming. For example, in response to that the prompt contents are not edited in history, a “set prompt content” control may be displayed to activate the prompt content editing page (namely the prompt panel); and in response to that the prompt contents are edited in history, an “edit prompt content” control may be displayed to activate the prompt content editing page (namely the prompt panel);
illegal dialogue information and dialogue editing box may be displayed in the prompt panel, and the filled introduction prompt contents will be displayed in the live streaming screen and are only visible to the user (such as streamer); the user clicks the dialogue editing box to activate a keyboard and enter an editing status; in response to that there is no content to be edited currently, it may be returned to the previous page; and in response to that there is content to be edited currently, a confirmation pop-up window may be triggered.

In addition, the prompt content panel may also display some dialogues, such as prompt contents like reference dialogue, hot-sale dialogue and goods information; in response to that the user clicks a use control corresponding to a certain prompt content, it will be considered as to use this prompt content, then prompt content will be automatically input to the editor, the editor enters the editing status, and the user may click the editor to edit the dialogue; or the user directly clicks to confirm, and at the moment, the prompt content inputted in the editing area may be set as the prompt content of the recommended object.

In the live streaming process, a teleprompting component may be displayed, and the prompt content independently edited by the user is preferentially displayed; in response to that there is no prompt content independently edited by the user, the recommended dialogue of the platform may be displayed. That is, in response to that the user does not set the prompt content, the recommended dialogue of the platform is displayed for the user to introduce.

It may be recognized that the priority of the independently edited prompt content is higher than that of the recommended prompt content of the platform, that is, in response to that the user or a central control operator initiates teleprompting for goods in a central controller, or the user independently sets the prompt content, the goods prompt content is preferentially displayed; and in response to that there is no independently edited prompt content, the prompt content is recommended based on the goods in the current introducing status.

Further, the priority of the goods with prompt content is higher than that of the goods in the current introducing status, that is, in response to that the teleprompting is initiated in the central controller, the prompt content of the corresponding goods is preferentially displayed; and in response to that the teleprompting is not initiated in the central controller, the teleprompting is triggered based on a goods introduction behavior, and in response to that the user initiates goods introduction, the corresponding prompt content is displayed at the same time.

In addition, it may initiate to switch the prompt content through the central controller or the user may switch goods introduction, and at the moment, the corresponding prompt content may be switched with the goods switching.

The prompter may be folded by default, and may be unfolded by clicking; after being unfolded, the prompter may adapt to the height according to the text content, and in response to that the text display range is exceeded under the limit height, a container needs to display a sliding indicator and support up-down sliding for browsing.

Whether in the unfolded status or the folded status, the prompter may support dragging in a fixed range along a Y axis, and may support long pressing to trigger to close a module menu.

Further, it may also support the user to select to close the current prompt content or all prompt contents; in response to that it is selected to close the current prompt content, the menu is closed and the teleprompting component is hidden, and it is normally to display in response to that there is prompt content for goods in the next introduction; and in response to that it is selected to close all prompt contents, the menu is closed and the teleprompting component is not displayed any more, and meanwhile, a prompt switch in the settings is synchronously closed.

FIG. 8 is a structural schematic diagram of a prompt content display apparatus provided by an embodiment of the present disclosure; the apparatus is applicable to display of a prompt content of an introduced object in a live streaming page; the apparatus be implemented by software and/or hardware and is generally integrated on an electronic device.

As shown in FIG. 8, the apparatus includes:
a receiving module 310, configured to receive a first trigger operation for a preset control in a live streaming page;
an acquisition module 320, configured to: in response to the first trigger operation, determine a first recommended object in the live streaming page according to a status of a recommended object in a recommended object list corresponding to the live streaming page, and acquire first prompt content corresponding to the first recommended object; and
a content display module 330, configured to display the first prompt content in the live streaming page.

The embodiment of the present disclosure provides the prompt content display apparatus, which includes: receiving the first trigger operation for the preset control in the live streaming page through the receiving module; in response to the first trigger operation, determining the first recommended object in the live streaming page according to the status of the recommended object in a recommended object list corresponding to the live streaming page, and acquiring the first prompt content corresponding to the first recommended object, through the acquisition module; and displaying the first prompt content in the live streaming page through the content display module. Through the apparatus, the first recommended object in the live streaming page is determined in response to the first trigger operation for the preset control, so that the acquisition and display of the first prompt content are realized, the interaction steps of displaying the prompt content are simplified, and thus the user experience is improved.

Optionally, the prompt content display apparatus provided by the embodiment of the present disclosure, further includes:
a control display module, configured to: before receiving a trigger operation for a preset control in a live streaming page, in response to that the recommended object of a prompt content exists in the live streaming page, keep displaying the preset control in the live streaming page; or
a first switching module, configured to, before receiving a trigger operation for a preset control in a live streaming page, in response to a control display operation, switch the preset control from an un-displayed status to a displayed status.

Optionally, the control display operation includes an introduction operation or a prompt content display operation for the second recommended object; the introduction operation is used for indicating to introduce the second recommended object; and the prompt content display operation is used for indicating to display the second prompt content corresponding to the second recommended object.

Optionally, the content display module 330 is specifically configured to:
increase a size of the preset control into a target size, and display the first prompt content in the preset control with the target size, the target size being determined based on the first prompt content.

Optionally, the prompt content display apparatus provided by the embodiment of the present disclosure further includes at least one of:
a second switching module, configured to: after displaying the first prompt content in the live streaming page, in response to an introduced object switching operation for a third recommended object, switch a currently introduced object in the live streaming page from the first recommended object to the third recommended object, and switch a current prompt content displayed in the live streaming page from the first prompt content to a third prompt content, the third prompt content being a prompt content corresponding to the third recommended object; and
a third switching module, configured to: after displaying the first prompt content in the live streaming page, in response to a prompt content switching operation for a fourth recommended object, keep the currently introduced object of the live streaming page as the first recommended object, and switch the current prompt content displayed in the live streaming page from the first prompt content to a fourth prompt content, the fourth prompt content being a prompt content corresponding to the fourth recommended object.

Optionally, the content display module 330 is specifically configured to:
display the first prompt content in a preset area of the live streaming page, wherein the preset area does not overlap with a live streaming information area and an interactive information area of the live streaming page.

The prompt content display apparatus provided by the embodiment of the present disclosure further includes:
an adjusting module, configured to: in response to a position adjusting operation performed in the live streaming page, adjust a display position of the first prompt content within a preset position region, a starting position of the preset position region being a first boundary of the live streaming information area, and an ending position of the preset position region being a second boundary of the interactive information area. Optionally, the prompt content display apparatus provided by the embodiment of the present disclosure further includes:
a first canceling module, configured to: in response to a first teleprompting canceling operation in the live streaming page, cancel a display of the preset control and a current prompt content displayed in the live streaming page, and adjust a recommended object corresponding to the current prompt content to be in a preset status; and
a second canceling module, configured to: in response to a second teleprompting canceling operation in the live streaming page, cancel the display of the preset control and the current prompt content displayed in the live streaming page, and adjust the recommended object in the recommended object list to be in the preset status,
a corresponding prompt content for the recommended object in the preset status is not displayed in the live streaming page in an introduction process.

Optionally, the prompt content display apparatus provided by the embodiment of the present disclosure further includes:
a panel display module, configured to: in response to a prompt content editing operation for a fifth recommended object, display a prompt panel for the fifth recommended object, wherein the prompt panel comprises an editing area and a display area, the editing area is configured to edit a fifth prompt content of the fifth recommended object, and the display area is configured to display at least one reference prompt content corresponding to the fifth recommended object;
an input module, configured to: in response to a second trigger operation for a target reference prompt content in the at least one reference prompt content, input the target reference prompt content into the editing area; and
a setting module, configured to: in response to an editing completion operation, set a prompt content inputted in the editing area as the fifth prompt content of the fifth recommended object.

Optionally, the first prompt content is a recommended prompt content or a prompt content edited by the user, and the prompt content edited by the user is obtained by the user editing at a local terminal and/or other terminals than the local terminal.

The prompt content display apparatus may perform the prompt content display method provided by any embodiment of the present disclosure, and has corresponding functional modules and beneficial effect of performing the method.

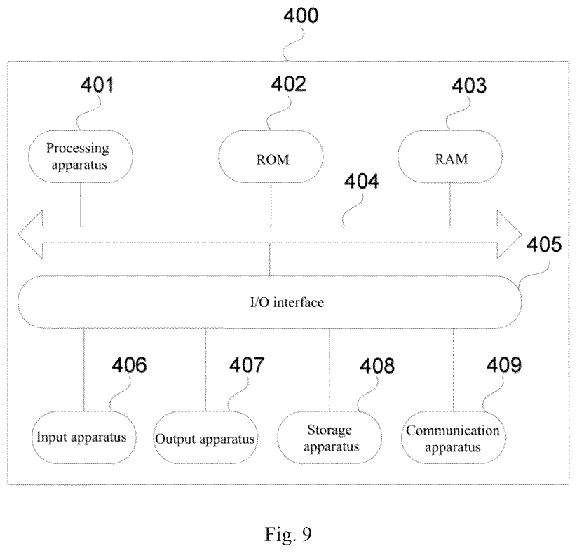

Referring to FIG. 9, FIG. 9 illustrates a schematic structural diagram of an electronic device 400 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 400 may include a processing apparatus 401 (e.g., a central processing unit, a graphics processing unit, etc.), which may perform various suitable actions and processing according to a program stored in a read-only memory (ROM) 402 or a program loaded from a storage apparatus 408 into a random-access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 409 may allow the electronic device 400 to be in wireless or wired communication with other devices to exchange data. While FIG. 9 illustrates the electronic device 400 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that may be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: receiving a first trigger operation for a preset control in a live streaming page; in response to the first trigger operation, determining a first recommended object in the live streaming page according to a status of a recommended object in a recommended object list corresponding to the live streaming page, and acquiring first prompt content corresponding to the first recommended object; and displaying the first prompt content in the live streaming page.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, may be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, example one provides a prompt content display method, comprising:
receiving a first trigger operation for a preset control in a live streaming page;
in response to the first trigger operation, determining a first recommended object in the live streaming page according to a status of a recommended object in a recommended object list corresponding to the live streaming page, and acquiring first prompt content corresponding to the first recommended object; and
displaying the first prompt content in the live streaming page.

According to one or more embodiments of the present disclosure, example two according to the method of example one, before the receiving a trigger operation for a preset control in a live streaming page, the method further comprises:
in response to that the recommended object with a prompt content exists in the live streaming page, keeping displaying the preset control in the live streaming page; or
in response to a control display operation, switching the preset control from an un-displayed status to a displayed status.

According to one or more embodiments of the present disclosure, example three according to the method of example two, the control display operation comprises an introduction operation or a prompt content display operation for a second recommended object, the introduction operation is configured to indicate to introduce the second recommended object; and the prompt content display operation is configured to indicate to display a second prompt content corresponding to the second recommended object.

According to one or more embodiments of the present disclosure, example four according to the method of example one, the displaying the first prompt content in the live streaming page comprises:
increasing a size of the preset control into a target size, and displaying the first prompt content in the preset control with the target size, wherein the target size is determined based on the first prompt content.

According to one or more embodiments of the present disclosure, example five according to the method of example one, after the displaying the first prompt content in the live streaming page, the method further comprises at least one of:
in response to an introduced object switching operation for a third recommended object, switching a currently introduced object in the live streaming page from the first recommended object to the third recommended object, and switching a current prompt content displayed in the live streaming page from the first prompt content to a third prompt content, wherein the third prompt content is a prompt content corresponding to the third recommended object; and
in response to a prompt content switching operation for a fourth recommended object, keeping the currently introduced object of the live streaming page as the first recommended object, and switching the current prompt content displayed in the live streaming page from the first prompt content to a fourth prompt content, wherein the fourth prompt content is a prompt content corresponding to the fourth recommended object.

According to one or more embodiments of the present disclosure, example six according to the method of any one of examples one to five, the displaying the first prompt content in the live streaming page comprises:
displaying the first prompt content in a preset area of the live streaming page, wherein the preset area does not overlap with a live streaming information area and an interactive information area of the live streaming page; and
the method further comprises:
in response to a position adjusting operation performed in the live streaming page, adjusting a display position of the first prompt content within a preset position region, wherein a starting position of the preset position region is a first boundary of the live streaming information area, and an ending position of the preset position region is a second boundary of the interactive information area.

According to one or more embodiments of the present disclosure, example seven according to the method of any one of examples one to five, further comprising:
in response to a first teleprompting canceling operation performed in the live streaming page, canceling a display of the preset control and a current prompt content displayed in the live streaming page, and adjusting a recommended object corresponding to the current prompt content to be in a preset status; and
in response to a second teleprompting canceling operation performed in the live streaming page, canceling the display of the preset control and the current prompt content displayed in the live streaming page, and adjusting the recommended object in the recommended object list to be in the preset status,
wherein a corresponding prompt content for the recommended object in the preset status is not displayed in the live streaming page in an introduction process.

According to one or more embodiments of the present disclosure, example eight according to the method of any one of examples one to five, further comprising:
in response to a prompt content editing operation for a fifth recommended object, displaying a prompt panel for the fifth recommended object, wherein the prompt panel comprises an editing area and a display area, the editing area is configured to edit a fifth prompt content of the fifth recommended object, and the display area is configured to display at least one reference prompt content corresponding to the fifth recommended object;
in response to a second trigger operation for a target reference prompt content in the at least one reference prompt content, inputting the target reference prompt content into the editing area; and
in response to an editing completion operation, setting a prompt content inputted in the editing area as the fifth prompt content of the fifth recommended object.

According to one or more embodiments of the present disclosure, example nine according to the method of any one of examples one to five, wherein the first prompt content is a recommended prompt content or a prompt content edited by a user, and the prompt content edited by the user is obtained by the user editing at a local terminal and/or other terminals than the local terminal.

According to one or more embodiments of the present disclosure, example ten provides prompt content display apparatus, comprising:
a receiving module, configured to receive a first trigger operation for a preset control in a live streaming page;
an acquisition module, configured to: in response to the first trigger operation, determine a first recommended object in the live streaming page according to a status of a recommended object in a recommended object list corresponding to the live streaming page, and acquire first prompt content corresponding to the first recommended object; and
a content display module, configured to display the first prompt content in the live streaming page.

According to one or more embodiments of the present disclosure, example eleven provides an electronic device, comprising:
one or more processors; and
a memory configured to store one or more computer programs;
when the one or more computer programs are executed by the at least one processor, the one or more processors implement the prompt content display method according to any one of examples one to nine.

According to one or more embodiments of the present disclosure, example twelve provides a computer-readable storage medium, wherein the computer-readable storage medium stores a computer program which, when executed by a processor, implement the prompt content display method according to any one of examples one to nine.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A prompt content display method, comprising:
receiving a first trigger operation for a preset control in a live streaming page;
in response to the first trigger operation, determining a first recommended object in the live streaming page according to a status of a recommended object in a recommended object list corresponding to the live streaming page, and acquiring first prompt content corresponding to the first recommended object; and
displaying the first prompt content in the live streaming page.

2. The method according to claim 1, wherein before the receiving a first trigger operation for a preset control in a live streaming page, the method further comprises:
in response to that the recommended object with a prompt content exists in the live streaming page, keeping displaying the preset control in the live streaming page; or
in response to a control display operation, switching the preset control from an un-displayed status to a displayed status.

3. The method according to claim 2, wherein the control display operation comprises an introduction operation or a prompt content display operation for a second recommended object, the introduction operation is configured to indicate to introduce the second recommended object; and the prompt content display operation is configured to indicate to display a second prompt content corresponding to the second recommended object.

4. The method according to claim 1, wherein the displaying the first prompt content in the live streaming page comprises:
increasing a size of the preset control into a target size, and displaying the first prompt content in the preset control with the target size, wherein the target size is determined based on the first prompt content.

5. The method according to claim 1, wherein after the displaying the first prompt content in the live streaming page, the method further comprises at least one of:
in response to an introduced object switching operation for a third recommended object, switching a currently introduced object in the live streaming page from the first recommended object to the third recommended object, and switching a current prompt content displayed in the live streaming page from the first prompt content to a third prompt content, the third prompt content being a prompt content corresponding to the third recommended object; and
in response to a prompt content switching operation for a fourth recommended object, keeping the currently introduced object of the live streaming page as the first recommended object, and switching the current prompt content displayed in the live streaming page from the first prompt content to a fourth prompt content, the fourth prompt content being a prompt content corresponding to the fourth recommended object.

6. The method according to claim 1, wherein the displaying the first prompt content in the live streaming page comprises:
displaying the first prompt content in a preset area of the live streaming page, wherein the preset area does not overlap with a live streaming information area and an interactive information area of the live streaming page; and
the method further comprises:
in response to a position adjusting operation performed in the live streaming page, adjusting a display position of the first prompt content within a preset position region, a starting position of the preset position region being a first boundary of the live streaming information area, and an ending position of the preset position region being a second boundary of the interactive information area.

7. The method according to claim 1, further comprising:
in response to a first teleprompting canceling operation performed in the live streaming page, canceling a display of the preset control and a current prompt content displayed in the live streaming page, and adjusting a recommended object corresponding to the current prompt content to be in a preset status; and
in response to a second teleprompting canceling operation performed in the live streaming page, canceling the display of the preset control and the current prompt content displayed in the live streaming page, and adjusting the recommended object in the recommended object list to be in the preset status;
wherein a corresponding prompt content for the recommended object in the preset status is not displayed in the live streaming page in an introduction process.

8. The method according to claim 1, further comprising:
in response to a prompt content editing operation for a fifth recommended object, displaying a prompt panel for the fifth recommended object, wherein the prompt panel comprises an editing area and a display area, the editing area is configured to edit a fifth prompt content of the fifth recommended object, and the display area is configured to display at least one reference prompt content corresponding to the fifth recommended object;
in response to a second trigger operation for a target reference prompt content in the at least one reference prompt content, inputting the target reference prompt content into the editing area; and
in response to an editing completion operation, setting a prompt content inputted in the editing area as the fifth prompt content of the fifth recommended object.

9. The method according to claim 1, wherein the first prompt content is a recommended prompt content or a prompt content edited by a user, and the prompt content edited by the user is obtained by the user editing at a local terminal and/or other terminals than the local terminal.

10. The method according to claim 1, wherein the determining a first recommended object in the live streaming page according to a status of a recommended object in a recommended object list corresponding to the live streaming page comprises:
determining the first recommended object according to an introducing status of the recommended object, determining a recommended object in a current introducing status as the first recommended object, determining a recommended object in a non-introducing status as the recommended object other than the first recommended object, and determining the introduction status according to a display status of an introduction control.

11. The method according to claim 1, wherein the displaying the first prompt content in the live streaming page, comprises:
generating a mask containing the first prompt content in the live streaming page to realize a display of the first prompt content; or, displaying the first prompt content by changing a display form of the preset control on a basis of the preset control.

12. The method according to claim 4, wherein the target size is further adjusted based on a size of the live streaming page.

13. (canceled)

14. An electronic device, comprising:
at least one processor; and
a memory in communication connection with the at least one processor;
the memory stores computer programs that are executed by the at least one processor; and
the computer programs are executed by the at least one processor to cause the at least one processor to implement a prompt content display method, which comprises:
receiving a first trigger operation for a preset control in a live streaming page;
in response to the first trigger operation, determining a first recommended object in the live streaming page according to a status of a recommended object in a recommended object list corresponding to the live streaming page, and acquiring first prompt content corresponding to the first recommended object; and
displaying the first prompt content in the live streaming page.

15. A computer-readable storage medium, wherein the computer-readable storage medium is configured to store computer instructions which, when executed by a processor, implement a prompt content display method, which comprises:
receiving a first trigger operation for a preset control in a live streaming page;
in response to the first trigger operation, determining a first recommended object in the live streaming page according to a status of a recommended object in a recommended object list corresponding to the live streaming page, and acquiring first prompt content corresponding to the first recommended object; and
displaying the first prompt content in the live streaming page.

16. The electronic device according to claim 14, wherein before the receiving a first trigger operation for a preset control in a live streaming page, the at least one processor is further caused to:
in response to that the recommended object with a prompt content exists in the live streaming page, keeping displaying the preset control in the live streaming page; or
in response to a control display operation, switching the preset control from an un-displayed status to a displayed status.

17. The electronic device according to claim 16, wherein the control display operation comprises an introduction operation or a prompt content display operation for a second recommended object, the introduction operation is configured to indicate to introduce the second recommended object; and the prompt content display operation is configured to indicate to display a second prompt content corresponding to the second recommended object.

18. The electronic device according to claim 14, wherein the at least one processor is further caused to:
increasing a size of the preset control into a target size, and displaying the first prompt content in the preset control with the target size, wherein the target size is determined based on the first prompt content.

19. The electronic device according to claim 14, wherein after the displaying the first prompt content in the live streaming page, the at least one processor is further caused to at least one of:
in response to an introduced object switching operation for a third recommended object, switching a currently introduced object in the live streaming page from the first recommended object to the third recommended object, and switching a current prompt content displayed in the live streaming page from the first prompt content to a third prompt content, the third prompt content being a prompt content corresponding to the third recommended object; and
in response to a prompt content switching operation for a fourth recommended object, keeping the currently introduced object of the live streaming page as the first recommended object, and switching the current prompt content displayed in the live streaming page from the first prompt content to a fourth prompt content, the fourth prompt content being a prompt content corresponding to the fourth recommended object.

20. The electronic device according to claim 14, wherein the at least one processor is further caused to:
displaying the first prompt content in a preset area of the live streaming page, wherein the preset area does not overlap with a live streaming information area and an interactive information area of the live streaming page; and
the method further comprises:
in response to a position adjusting operation performed in the live streaming page, adjusting a display position of the first prompt content within a preset position region, a starting position of the preset position region being a first boundary of the live streaming information area, and an ending position of the preset position region being a second boundary of the interactive information area.

21. The electronic device according to claim 14, wherein the at least one processor is further caused to:
in response to a first teleprompting canceling operation performed in the live streaming page, canceling a display of the preset control and a current prompt content displayed in the live streaming page, and adjusting a recommended object corresponding to the current prompt content to be in a preset status; and
in response to a second teleprompting canceling operation performed in the live streaming page, canceling the display of the preset control and the current prompt content displayed in the live streaming page, and adjusting the recommended object in the recommended object list to be in the preset status;
wherein a corresponding prompt content for the recommended object in the preset status is not displayed in the live streaming page in an introduction process.
